(19) United States
(12) Patent Application Publication
(10) Pub. No.: US 2025/0214869 A1
(43) Pub. Date: Jul. 3, 2025

(54) PROCESSING A FLUID EMULSION

(71) Applicant: Saudi Arabian Oil Company, Dhahran (SA)

(72) Inventors: Eiman Hassan Al Munif, Saihat (SA); Luai A. Alhamad, Dammam (SA); Damian Pablo San Roman Alerigi, Al-Khoba (SA)

(21) Appl. No.: 18/402,220

(22) Filed: Jan. 2, 2024

(51) Int. Cl. C02F 1/36; B01D 17/04; C02F 101/32

(52) U.S. Cl. CPC C02F 1/36; B01D 17/04; C02F 2101/32

(57) ABSTRACT

A system includes a fluid container formed of a conductive metal and at least one opening; a plurality of electromagnetic acoustic transducers (EMATs) coupled with the fluid container; and a control system communicably coupled to each of the plurality of EMATs and configured to transmit a pattern of electrical signals to the plurality of EMATs to cause the plurality of EMATs to energize so that each EMAT generates an electromagnetic field with the at least one coil and a magnetic field with the at least one magnet to interact with the electromagnetic field to generate acoustic wave energy directed through the fluid container and to a hydrocarbon fluid emulsion within the fluid container to at least partially separate the hydrocarbon fluid emulsion into at least a water phase and a hydrocarbon phase.

### TECHNICAL FIELD

This disclosure relates to systems and methods for processing a fluid emulsion and more particularly, separating or breaking a fluid emulsion within a pipeline or container with one or more electromagnetic acoustic transducers (EMATs).

### BACKGROUND

Some of the crude oil being produced in the world comes to the surface associated with appreciable proportions of water in emulsified form. Even where the percentage of emulsion in total production is very low, storage tanks or pipelines tend, eventually, to accumulate significant volumes of emulsion. Emulsion resolution is, therefore, an important element in the handling of crude oil, from the time it is produced until it enters the refining process.

### SUMMARY

In an example implementation, a fluid emulsion processing apparatus includes a sleeve configured to couple to at least a portion of a fluid container that includes at least one opening and is configured to at least partially enclose a fluid emulsion, and a plurality of electromagnetic acoustic transducers (EMATs) attached to the sleeve. Each of the plurality of EMATs includes at least one conductive coil and at least one magnet positioned within or near the at least one conductive coil. The plurality of EMATs include a plurality of groups of EMATs with each group including at least one EMAT to form an array of EMATs. The system includes a control system communicably coupled to each of the plurality of EMATs and configured to perform operations including generating a plurality of electrical signals to transmit to the plurality of EMATs; and based on the transmission of the plurality of electrical signals, causing the plurality of EMATs to energize so that each EMAT generates an electromagnetic field with the at least one coil and a magnetic field with the at least one magnet to interact with the electromagnetic field such that the interaction of the magnetic field and the electromagnetic field causes acoustic wave energy to travel through the sleeve and the fluid container and to the fluid emulsion to at least partially separate two or more fluid constituents of the fluid emulsion.

In an aspect combinable with the example implementation, the acoustic wave energy includes radial wave energy and axisymmetric shear waves.

In another aspect combinable with any of the previous aspects, the operation of causing the plurality of EMATs to energize so that each EMAT generates the electromagnetic field with the at least one coil and the magnetic field with the at least one magnet to interact with the electromagnetic field further includes causing the plurality of EMATs to energize so that each EMAT generates the electromagnetic field with the at least one coil and the magnetic field with the at least one magnet to interact with the electromagnetic field such that the interaction of the magnetic field and the electromagnetic field causes vibration of the sleeve, and from the sleeve to the fluid container, to at least partially separate two or more fluid constituents of the fluid emulsion.

In another aspect combinable with any of the previous aspects, the plurality of groups of EMATs are formed into linear arrangements of EMATs within each group in parallel with an axis of the fluid container.

In another aspect combinable with any of the previous aspects, the fluid container includes a pipeline that includes an inlet and an outlet, and the axis includes a longitudinal axis of the fluid container.

In another aspect combinable with any of the previous aspects, the sleeve is at least 8 feet in length and is between 4 and 10 inches in diameter.

In another aspect combinable with any of the previous aspects, the fluid container includes a tank that includes an inlet, and the axis includes a centerline axis of the fluid container.

In another aspect combinable with any of the previous aspects, the operation of causing the plurality of EMATs to energize includes causing the plurality of EMATs to energize in a synchronous or asynchronous pattern.

In another aspect combinable with any of the previous aspects, the acoustic wave energy includes a frequency of 20 kHz through the sleeve.

In another aspect combinable with any of the previous aspects, the plurality of EMATs are attached to the sleeve with an adhesive or bonding agent.

In another aspect combinable with any of the previous aspects, the sleeve is included of a conductive metal.

In another example implementation, a method of processing a fluid emulsion includes installing a sleeve to at least a portion of a fluid container that includes at least one opening. The sleeve includes a plurality of electromagnetic acoustic transducers (EMATs) attached to an outer surface of the sleeve, where each of the plurality of EMATs includes at least one conductive coil and at least one magnet positioned within or near the at least one conductive coil. The plurality of EMATs includes a plurality of groups of EMATs with each group including at least one EMAT to form an array of EMATs. The method includes generating, with a control system communicably coupled to each of the plurality of EMATs, a plurality of electrical signals; transmitting the plurality of electrical signals from the control system to the plurality of EMATs; and based on the transmission of the plurality of electrical signals, causing the plurality of EMATs to energize so that each EMAT generates an electromagnetic field with the at least one coil and a magnetic field with the at least one magnet to interact with the electromagnetic field such that the interaction of the magnetic field and the electromagnetic field causes acoustic wave energy to travel through the sleeve and the fluid container and to a fluid emulsion at least partially enclosed within the fluid container to at least partially separate two or more fluid constituents of the fluid emulsion.

In an aspect combinable with the example implementation, the acoustic wave energy includes radial wave energy and axisymmetric shear waves.

In another aspect combinable with any of the previous aspects, causing the plurality of EMATs to energize so that each EMAT generates the electromagnetic field with the at least one coil and the magnetic field with the at least one magnet to interact with the electromagnetic field further includes causing the plurality of EMATs to energize so that each EMAT generates the electromagnetic field with the at least one coil and the magnetic field with the at least one magnet to interact with the electromagnetic field such that the interaction of the magnetic field and the electromagnetic field causes vibration of the sleeve, and from the sleeve to the fluid container, to at least partially separate two or more fluid constituents of the fluid emulsion.

In another aspect combinable with any of the previous aspects, the plurality of groups of EMATs are formed into linear arrangements of EMATs within each group in parallel with an axis of the fluid container.

In another aspect combinable with any of the previous aspects, the fluid container includes a pipeline that includes an inlet and an outlet, and the axis includes a longitudinal axis of the fluid container.

In another aspect combinable with any of the previous aspects, the sleeve is at least 8 feet in length and is between 4 and 10 inches in diameter.

In another aspect combinable with any of the previous aspects, the fluid container includes a tank that includes an inlet, and the axis includes a centerline axis of the fluid container.

In another aspect combinable with any of the previous aspects, causing the plurality of EMATs to energize includes causing the plurality of EMATs to energize in a synchronous or asynchronous pattern.

In another aspect combinable with any of the previous aspects, the acoustic wave energy includes a frequency of 20 kHz through the sleeve.

In another aspect combinable with any of the previous aspects, the plurality of EMATs are attached to the sleeve with an adhesive or bonding agent.

In another aspect combinable with any of the previous aspects, the sleeve is included of a conductive metal.

In another example implementation, a system includes a fluid container formed of a conductive metal and including at least one opening; a plurality of electromagnetic acoustic transducers (EMATs) coupled with the fluid container, with each of the plurality of EMATs including at least one conductive coil and at least one magnet positioned adjacent the at least one conductive coil, and the plurality of EMATs including a plurality of groups of EMATs with each group including at least one EMAT; and a control system communicably coupled to each of the plurality of EMATs and configured to transmit a pattern of electrical signals to the plurality of EMATs to cause the plurality of EMATs to energize so that each EMAT generates an electromagnetic field with the at least one coil and a magnetic field with the at least one magnet to interact with the electromagnetic field to generate acoustic wave energy directed through the fluid container and to a hydrocarbon fluid emulsion within the fluid container to at least partially separate the hydrocarbon fluid emulsion into at least a water phase and a hydrocarbon phase.

In an aspect combinable with the example implementation, the hydrocarbon phase includes oil.

In another aspect combinable with any of the previous aspects, the interaction of the magnetic field and the electromagnetic field generates vibration energy directed through the fluid container and to the hydrocarbon fluid emulsion within the fluid container to at least partially separate the hydrocarbon fluid emulsion into at least the water phase and the hydrocarbon phase.

In another aspect combinable with any of the previous aspects, the fluid container includes a pipeline, and the hydrocarbon fluid emulsion includes a dynamic flow of a mixed-phase hydrocarbon fluid that includes the water phase and the hydrocarbon phase.

In another aspect combinable with any of the previous aspects, a thickness of the fluid container is sufficient for the acoustic wave energy to achieve a frequency of 20 KHz.

In another aspect combinable with any of the previous aspects, the conductive metal is a first conductive metal, and the plurality of EMATs are coupled with the fluid container through a sleeve included of a second conductive metal.

In another aspect combinable with any of the previous aspects, the first and second conductive metals are different.

Implementations of fluid processing systems and methods according to the present disclosure may also include one or more of the following features. For example, implementations according to the present disclosure can enable the use of a non-contact operation to separate a fluid emulsion in that a transducer that generates wave energy for the separation is not in physical contact with the fluid emulsion, itself. Such a feature can be particularly beneficial when separating certain fluid emulsions, as direct contact may lead to further emulsion formation or unwanted reactions. As another example, implementations according to the present disclosure can provide for reduced chemical usage by using electromagnetic acoustic transducers in contact with a metal substrate (such as a fluid container or sleeve about a fluid container), thereby reducing a need for large quantities of chemical demulsifiers or emulsion breakers. This can lead to cost savings and reduce an environmental impact.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of an example implementation of a fluid processing system according to the present disclosure.

FIG. 2 is a schematic illustration of another example implementation of a fluid processing system according to the present disclosure.

FIG. 3 is a schematic illustration of another example implementation of a fluid processing system according to the present disclosure.

FIG. 4 is a schematic illustration of a controller or control system for a fluid processing system according to the present disclosure.

### DETAILED DESCRIPTION

The present disclosure describes example implementations of a fluid processing system that, for example, can be operated to disrupt and separate a fluid emulsion within a conduit (for example, an above or underground pipeline) or a container (such as a tank) that is comprised of a mixture of two or more immiscible liquids, such as oil and water, that are typically challenging to separate. Example implementations of a fluid processing system according to the present disclosure include electromagnetic acoustic transducers (EMATs) arranged on a substrate in a phased array and operable to convert electrical energy into acoustic (or ultrasonic) energy waves using the principles of electromagnetic induction. The substrate can be a housing of a fluid container, such as a tank, a pipeline that carries a flow of a fluid, or a sleeve that fits around (all or partially) a fluid container that encloses a fluid. The fluid comprises two or more immiscible liquids within an emulsion, such as a mixture of an aqueous phase and organic phase. The organic phase can include a hydrocarbon fluid, such as oil.

In example implementations, a phased array of EMATs can be operated by a phase control system (or “control system”) that energizes the EMATs in a predetermined timing and phase to generate radial acoustic waves, axisymmetric shear waves, or both, by the interaction of an electromagnetic field and magnetic field generated by the EMATs. The wave energy can disrupt and separate the fluid emulsion into separate aqueous and organic phases. The energized EMATs can also produce vibration energy in the fluid container (through a sleeve or directly), which can also disrupt and separate the fluid emulsion into the separate aqueous and organic phases.

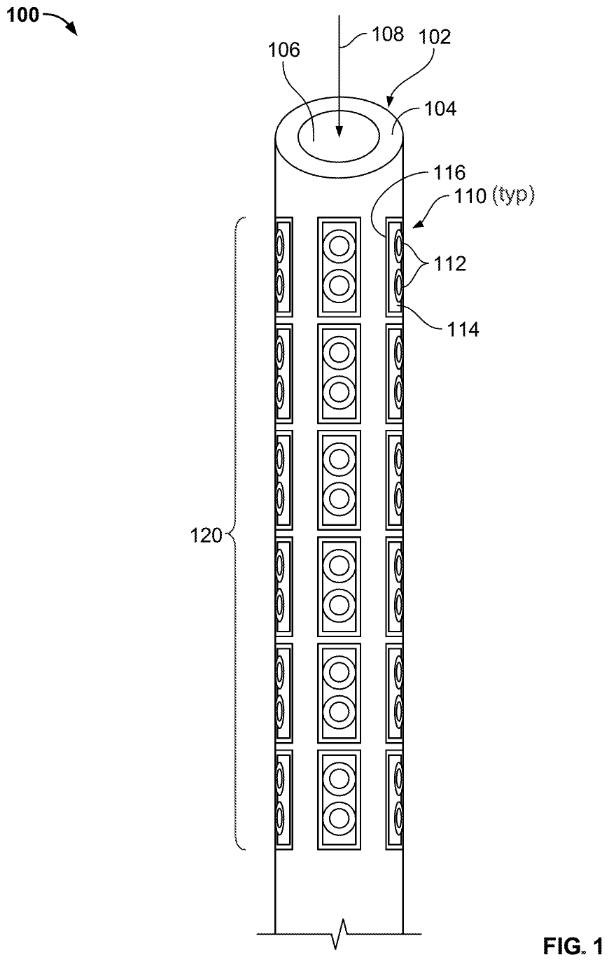

FIG. 1 is a schematic illustration of an example implementation of a fluid processing system 100 according to the present disclosure. As shown in this figure, EMATs 110 are coupled (for example, through an adhesive or bonding agent 116) to a fluid container 102 that includes an opening 106 into which a fluid emulsion 108 flows or is enclosed. In this example, the fluid container 102 is a pipeline 102 (or portion of pipeline 102) in which the fluid emulsion 108 flows dynamically (in other words, at a particular flow rate).

As shown in this example, the EMATs 110 are coupled directly to an exterior surface of the fluid container 102. Each EMAT 110 includes one or more electromagnetic coils 112, as well as a magnet 114 positioned within or near the coil 112. Generally, each EMAT 110 comprises a transducer that converts electrical energy (from an electrical signal provided from a control system as described herein) into acoustic or ultrasonic waves using electromagnetic induction. The coil 112 is a conductive wire wound into a specific pattern, such as a helical or solenoid winding pattern. In the case of a solenoid winding patter, the coil 112 is wound in a series of tight, close-packed turns to form a helix. When current of the electrical signal passes through the coil 112, the coil 112 generates a nearly uniform magnetic field inside the solenoid. When alternating current is passed through the coil 112, it generates an electromagnetic field about the EMAT 110.

The magnet 114, such as a permanent magnet, generates a magnetic field. When the EMAT 110 is energized by an electrical signal such that the coil 112 generates the electromagnetic field, the magnetic field generated by the magnet 114 interacts with the electromagnetic field generated by the coil 112 to produce the acoustic wave energy.

As shown in this example, groups 120 of EMATs 110 (with each group 120 including at least one EMAT 110 and, typically, multiple EMATs 110) are positioned on the fluid container 102 to form an array of EMATs 110. In the example of FIG. 1, the groups 120 are linear groups 120 that are oriented in parallel with a flow of the fluid emulsion 108 as shown. The linear groups 120 of the EMATs 110 can be coupled to the fluid container 102 concentrically about the entire circumference of the fluid container 102, as shown in this example. However, other groupings of the EMATs 110 are also contemplated by the present disclosure to form a phased array of EMATs 110. Generally, the phased array of EMATs 110 is positioned on the fluid container 102 such that optimal ultrasonic wave transmission and reception by the fluid container 102 (and the fluid emulsion 108) is achieved. Thus, the EMATs 110 can be preferably oriented in a manner in which the generated ultrasonic waves propagate efficiently along the structure of the fluid container 102.

The combination of the phased array of EMATs 110 and the structure of the fluid container 102 (as, for example, a conductive metal substrate) provides for a powerful and efficient system for breaking the fluid emulsion 108. The ultrasonic waves generated by the EMATs 110 propagate through the fluid container 102, causing mechanical agitation and disruption within the fluid emulsion 108. The example system 100 can also ensure an effective transmission of the ultrasonic waves while maintaining structural integrity and flexibility of the fluid container 102. The phased array of EMATs 110 can also allow for precise control and manipulation of the ultrasonic waves, for example, by applying alternating current to the EMATs 110 to create frequency vibrations within the fluid container 102 to target a resonance frequency of the fluid emulsion 108. This control can enable targeted treatment of different types of emulsions, whether the fluid emulsion is a hydrocarbon emulsion or otherwise.

As the ultrasonic waves propagate through the fluid emulsion 108, the fluid container 102 experiences the Lorentz force. This force is a result of the interaction between the magnetic field generated by the magnet 114 and electric currents induced in a wall 104 of the fluid container 102. The Lorentz force exerted on the fluid container 102 causes it to vibrate. The vibrations produced by the fluid container 102 transmit into the fluid emulsion 108 to induce controlled mechanical stress and agitation within the emulsion 108. This mechanical agitation disrupts the intermolecular forces holding the constituents in the fluid emulsion 108 together, causing the constituent droplets (for example, oil and water) to separate and coalesce.

The Lorentz force formula is defined as:

$$F = q ( E + v \times B ) ,$$

where F is the Lorentz force, q is the electric charge provided to the coil 112, E is the external electromagnetic field generated by the coil 112, v is a velocity of the acoustic or ultrasonic wave, and B is the magnetic field generated by the magnet 114. The combined action of electromagnetic excitation and mechanical vibrations delivered by the EMATs 110 can overcome the stability and viscosity of the fluid emulsion 108. The ultrasonic waves create localized pressure variations, cavitation, and shear forces within the fluid emulsion, which facilitate the detachment and recombination of the constituent (for example, oil and water) droplets. As a result, the fluid emulsion 108 breaks down into separate phases, allowing for easier separation and recovery of the individual components.

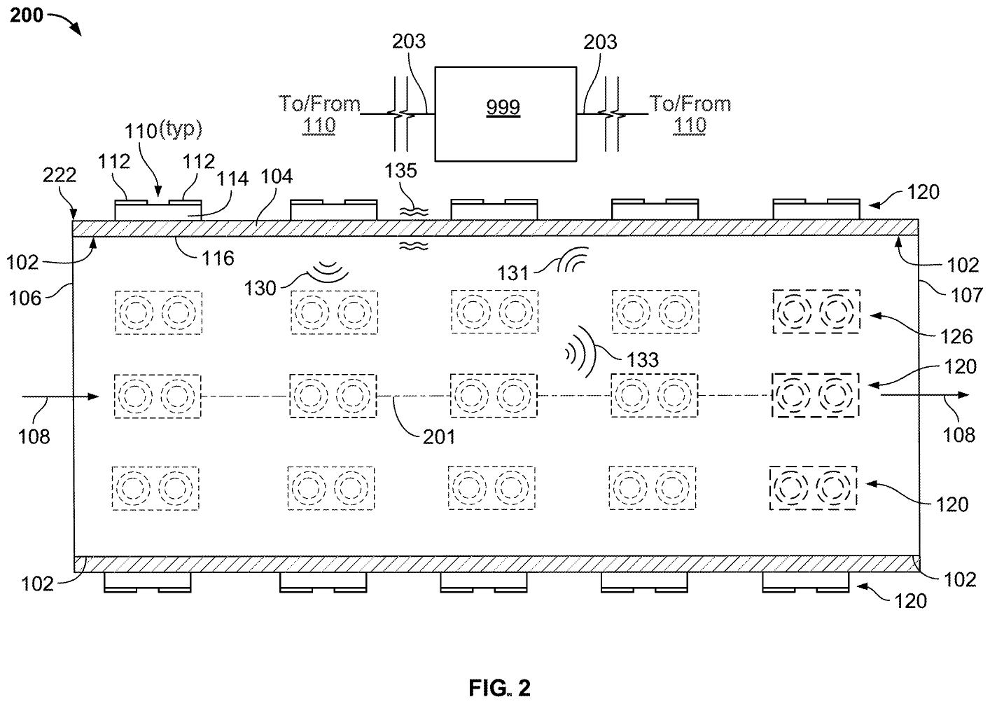

FIG. 2 is a schematic illustration of another example implementation of a fluid processing system 200 according to the present disclosure. This figure shows a cross-section of the fluid container 102 taken in parallel with a longitudinal axis 201, and, as shown, the fluid emulsion 108 flows into the opening 106 (for example, an inlet), through the fluid container 102, and out of an opening 107 (for example, an outlet 107). In this example implementation, the EMATs 110 in groups 120 are coupled (with some EMATs 110 shown in dashed line on a back side of the fluid container 102) to the fluid container 102 through a sleeve 222 that fits over or surrounds (at least partially) the fluid container 102. In this example, therefore, the EMATs 110 are attached (for example, with adhesive 116) to the sleeve 222, which, in turn, is in contact with the fluid container 102.

As previously described, energizing of the EMATs 110 causes acoustic or ultrasonic wave energy 130 to be transmitted into the fluid emulsion 108 (in this case, through the sleeve 222 and the fluid container 102). The acoustic wave energy 130 can be in the form of radial waves 131 that propagate in a radial direction within the fluid emulsion 108 (about the axis 201). The acoustic wave energy 130 can also propagate as axisymmetric shear waves (longitudinal or torsional) that act parallel to the axis 201 (the circumferential axis). The wave mode (radial and/or axisymmetric) can depend on the orientation of the poles of the magnets 114 in the EMATs 110.

As shown in this example, the system 200 includes a control system 999 communicably coupled (for example, through wires) to the EMATs 110 and, more specifically, to the coils 112 of the EMATs 110. Control system 999, in some aspects, is a phased array controller that operates to coordinate the timing and phase of electrical signals 203 sent to each EMAT 110 to energize the coils 112. Thus, control system 999 can facilitate precise manipulation of the ultrasonic waves 130 generated by the EMATs 110 by, for example, energizing each EMAT 110 in synchronous, asynchronous, or any other given pattern. By controlling the phased array of the groups 120 of the EMATs 110, the interference pattern of the propagating acoustic waves 130 and vibration 135 are controlled, thus providing higher amplitude waves in localized regions of the fluid emulsion 108 or steering the acoustic energy waves 130 in a particular direction within the fluid emulsion 108. In an example implementation, control system 999 includes one or more processors or microcontrollers that manage the input and output signals from the EMATs 110, a power supply to provide the electrical signals 203 to the EMATs 110 and other components of the control system 999, signal conditioning equipment that enhance, filter or modify the signals from EMATs 110, data storage. a user interface, and a communication module to provide data to a remote monitoring system or control if the system is operated from a distant location.

In this example implementation, the sleeve 222 can be formed of a non-ferrous, conductive metal material such as aluminum, copper, or steel (as example). The fluid container 102 can be made from the same conductive metal material, a different conductive metal material, or another material. In example implementations, the sleeve 222 can be between 4-10 inches in diameter (depending on the size of the fluid container 102) and between 6 and 10 feet long (such as 8 feet long). Generally, the dimensions of the sleeve 222, such as wall thickness and length, can be selected to optimize mechanical rigidity while allowing flexibility for the propagation of the ultrasonic waves 130 to generate the vibration 135 (in the sleeve 222 and fluid container 102). The sleeve 222, therefore, can be made of a relatively thin conductive metal substrate, such as aluminum or stainless steel. The choice of material of the sleeve 222 (or fluid container 102 in the implementation of FIG. 1) can depend on factors like mechanical strength, conductivity, and compatibility with the application environment. In some aspects, the sleeve 222 has a wall thickness sufficient to generate 20 KHz frequency of the acoustic wave energy 130.

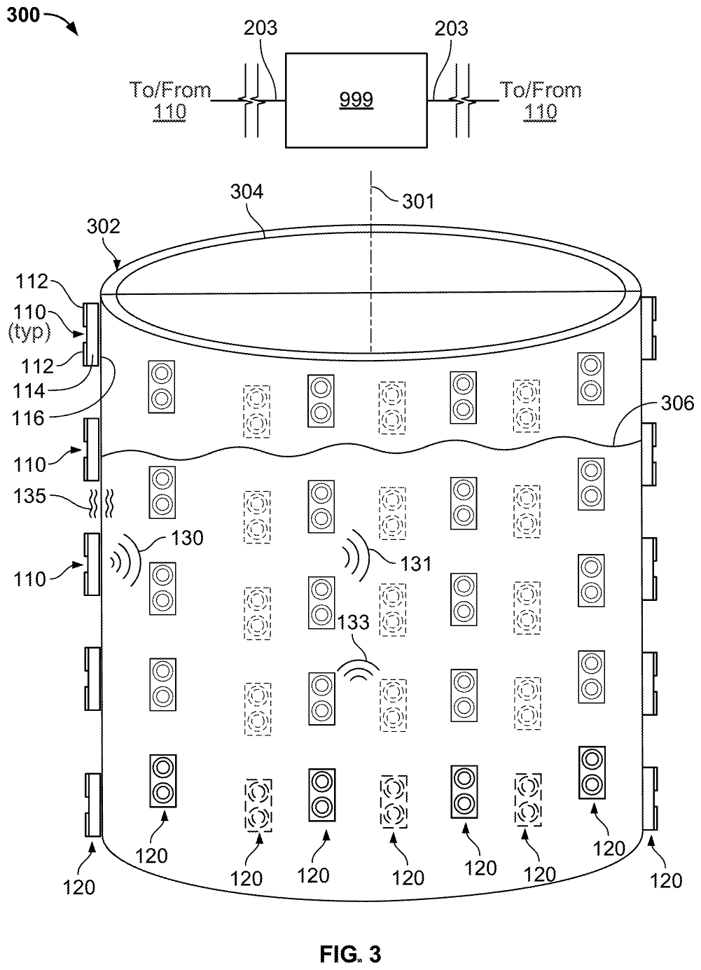

FIG. 3 is a schematic illustration of another example implementation of a fluid processing system 300 according to the present disclosure. This figure shows an example in which the fluid container 302 is a tank 302, which holds a static volume of a fluid emulsion 306 therewithin. The fluid emulsion 306 is poured (or otherwise provided) into the tank 302 through an opening 304. In this example implementation, the EMATs 110 in groups 120 are coupled to the tank 302 directly; alternatively, a sleeve or other housing (such as the sleeve 222) can be fit over or surround (at least partially) the tank 302 and the EMATs 110 can be attached to such a sleeve or housing.

Control system 999 in this implementation energizes the EMATs 110 to cause acoustic or ultrasonic wave energy 130 to be transmitted into the fluid emulsion 306 (in this case, through the tank 302). The acoustic wave energy 130 can be in the form of radial waves 131 that propagate in a radial direction within the fluid emulsion 108 (about the axis 301). The acoustic wave energy 130 can also propagate as axisymmetric shear waves (longitudinal or torsional) that act parallel to the axis 301 (the circumferential axis). The wave mode (radial and/or axisymmetric) can depend on the orientation of the poles of the magnets 114 in the EMATs 110. As with the system 200, control system 999 can facilitate precise manipulation of the ultrasonic waves 130 generated by the EMATs 110 by, for example, energizing each EMAT 110 in synchronous, asynchronous, or any other given pattern. By controlling the phased array of the groups 120 of the EMATs 110, the interference pattern of the propagating acoustic waves 130 and vibration 135 are controlled, thus providing higher amplitude waves in localized regions of the fluid emulsion 306 or steering the acoustic energy waves 130 in a particular direction within the fluid emulsion 306.

In this example implementation, the tank 302 can be formed of a non-ferrous, conductive metal material such as aluminum, copper, or steel (as example). A housing, or sleeve, if used over the tank 302, can be made from the same conductive metal material, a different conductive metal material, or another material. In example implementations, dimensions of the tank 302, such as wall thickness and length, can be selected to optimize mechanical rigidity while allowing flexibility for the propagation of the ultrasonic waves 130 to generate the vibration 135 (in the tank 302). The tank 302, therefore, can be made of a relatively thin conductive metal substrate, such as aluminum or stainless steel. The choice of material of the tank 302 can depend on factors like mechanical strength, conductivity, and compatibility with the application environment. In some aspects, the tank 302 has a wall thickness sufficient to generate 20 kHz frequency of the acoustic wave energy 130.

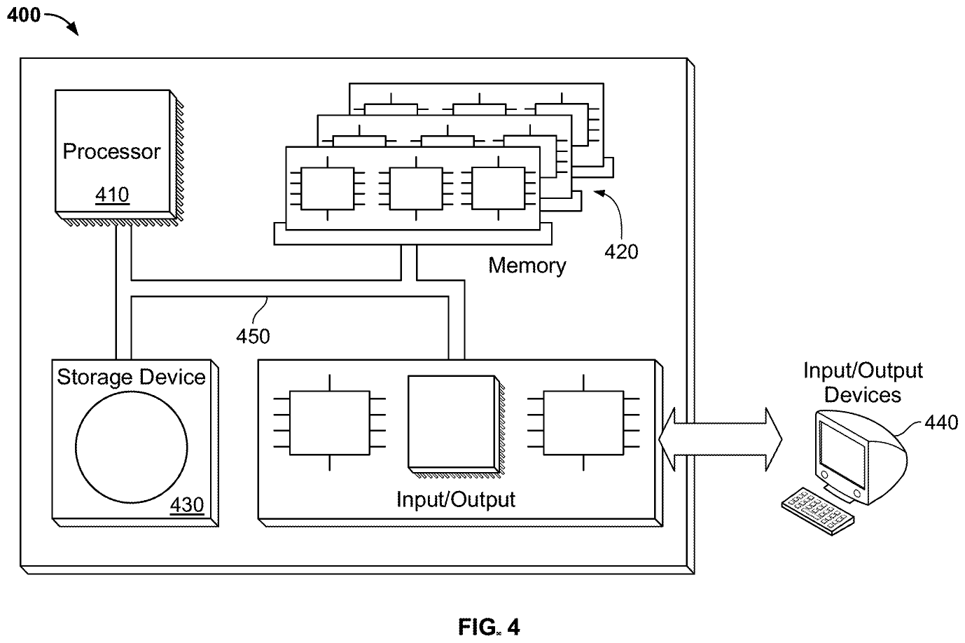

FIG. 4 is a schematic illustration of an example controller 400 (or control system) for a fluid processing system. For example, the controller 400 can be used for the operations described previously, for example as or as part of the control system 999. For example, the controller 400 may be communicably coupled with, or as a part of, a fluid processing system as described herein.

The controller 400 is intended to include various forms of digital computers, such as printed circuit boards (PCB), processors, digital circuitry, or otherwise that is part of a vehicle. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 400 includes a processor 410, a memory 420, a storage device 430, and an input/output device 440. Each of the components 410, 420, 430, and 440 are interconnected using a system bus 450. The processor 410 is capable of processing instructions for execution within the controller 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the controller 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the controller 400. In one implementation, the storage device 430 is a computer-readable medium. In various different implementations, the storage device 430 may be a floppy disk device, a hard disk device, an optical disk device, a tape device, flash memory, a solid state device (SSD), or a combination thereof.

The input/output device 440 provides input/output operations for the controller 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A fluid emulsion processing apparatus, comprising:
a sleeve configured to couple to at least a portion of a fluid container that comprises at least one opening and is configured to at least partially enclose a fluid emulsion;
a plurality of electromagnetic acoustic transducers (EMATs) attached to the sleeve, each of the plurality of EMATs comprising at least one conductive coil and at least one magnet positioned within or near the at least one conductive coil, the plurality of EMATs comprising a plurality of groups of EMATs with each group including at least one EMAT to form an array of EMATs; and
a control system communicably coupled to each of the plurality of EMATs and configured to perform operations comprising:
generating a plurality of electrical signals to transmit to the plurality of EMATs; and
based on the transmission of the plurality of electrical signals, causing the plurality of EMATs to energize so that each EMAT generates an electromagnetic field with the at least one coil and a magnetic field with the at least one magnet to interact with the electromagnetic field such that the interaction of the magnetic field and the electromagnetic field causes acoustic wave energy to travel through the sleeve and the fluid container and to the fluid emulsion to at least partially separate two or more fluid constituents of the fluid emulsion.

2. The apparatus of claim 1, wherein the acoustic wave energy comprises radial wave energy and axisymmetric shear waves.

3. The apparatus of claim 1, wherein the operation of causing the plurality of EMATs to energize so that each EMAT generates the electromagnetic field with the at least one coil and the magnetic field with the at least one magnet to interact with the electromagnetic field further comprises:
causing the plurality of EMATs to energize so that each EMAT generates the electromagnetic field with the at least one coil and the magnetic field with the at least one magnet to interact with the electromagnetic field such that the interaction of the magnetic field and the electromagnetic field causes vibration of the sleeve, and from the sleeve to the fluid container, to at least partially separate two or more fluid constituents of the fluid emulsion.

4. The apparatus of claim 1, wherein the plurality of groups of EMATs are formed into linear arrangements of EMATs within each group in parallel with an axis of the fluid container.

5. The apparatus of claim 4, wherein the fluid container comprises a pipeline that includes an inlet and an outlet, and the axis comprises a longitudinal axis of the fluid container.

6. The apparatus of claim 5, wherein the sleeve is at least 8 feet in length and is between 4 and 10 inches in diameter.

7. The apparatus of claim 4, wherein the fluid container comprises a tank that includes an inlet, and the axis comprises a centerline axis of the fluid container.

8. The apparatus of claim 1, wherein the operation of causing the plurality of EMATs to energize comprises causing the plurality of EMATs to energize in a synchronous or asynchronous pattern.

9. The apparatus of claim 1, wherein the acoustic wave energy comprises a frequency of 20 kHz through the sleeve.

10. The apparatus of claim 1, wherein the plurality of EMATs are attached to the sleeve with an adhesive or bonding agent.

11. The apparatus of claim 1, wherein the sleeve is comprised of a conductive metal.

12. A method of processing a fluid emulsion, comprising:
installing a sleeve to at least a portion of a fluid container that comprises at least one opening, the sleeve comprising a plurality of electromagnetic acoustic transducers (EMATs) attached to an outer surface of the sleeve, each of the plurality of EMATs comprising at least one conductive coil and at least one magnet positioned within or near the at least one conductive coil, the plurality of EMATs comprising a plurality of groups of EMATs with each group including at least one EMAT to form an array of EMATs;
generating, with a control system communicably coupled to each of the plurality of EMATs, a plurality of electrical signals;
transmitting the plurality of electrical signals from the control system to the plurality of EMATs; and
based on the transmission of the plurality of electrical signals, causing the plurality of EMATs to energize so that each EMAT generates an electromagnetic field with the at least one coil and a magnetic field with the at least one magnet to interact with the electromagnetic field such that the interaction of the magnetic field and the electromagnetic field causes acoustic wave energy to travel through the sleeve and the fluid container and to a fluid emulsion at least partially enclosed within the fluid container to at least partially separate two or more fluid constituents of the fluid emulsion.

13. The method of claim 12, wherein the acoustic wave energy comprises radial wave energy and axisymmetric shear waves.

14. The method of claim 12, wherein causing the plurality of EMATs to energize so that each EMAT generates the electromagnetic field with the at least one coil and the magnetic field with the at least one magnet to interact with the electromagnetic field further comprises:
causing the plurality of EMATs to energize so that each EMAT generates the electromagnetic field with the at least one coil and the magnetic field with the at least one magnet to interact with the electromagnetic field such that the interaction of the magnetic field and the electromagnetic field causes vibration of the sleeve, and from the sleeve to the fluid container, to at least partially separate two or more fluid constituents of the fluid emulsion.

15. The method of claim 12, wherein the plurality of groups of EMATs are formed into linear arrangements of EMATs within each group in parallel with an axis of the fluid container.

16. The method of claim 15, wherein the fluid container comprises a pipeline that includes an inlet and an outlet, and the axis comprises a longitudinal axis of the fluid container.

17. The method of claim 16, wherein the sleeve is at least 8 feet in length and is between 4 and 10 inches in diameter.

18. The method of claim 15, wherein the fluid container comprises a tank that includes an inlet, and the axis comprises a centerline axis of the fluid container.

19. The method of claim 12, wherein causing the plurality of EMATs to energize comprises causing the plurality of EMATs to energize in a synchronous or asynchronous pattern.

20. The method of claim 12, wherein the acoustic wave energy comprises a frequency of 20 kHz through the sleeve.

21. The method of claim 12, wherein the plurality of EMATs are attached to the sleeve with an adhesive or bonding agent.

22. The method of claim 12, wherein the sleeve is comprised of a conductive metal.

23. A system, comprising:
a fluid container formed of a conductive metal and comprising at least one opening;
a plurality of electromagnetic acoustic transducers (EMATs) coupled with the fluid container, each of the plurality of EMATs comprising at least one conductive coil and at least one magnet positioned adjacent the at least one conductive coil, the plurality of EMATs comprising a plurality of groups of EMATs with each group including at least one EMAT; and
a control system communicably coupled to each of the plurality of EMATs and configured to transmit a pattern of electrical signals to the plurality of EMATs to cause the plurality of EMATs to energize so that each EMAT generates an electromagnetic field with the at least one coil and a magnetic field with the at least one magnet to interact with the electromagnetic field to generate acoustic wave energy directed through the fluid container and to a hydrocarbon fluid emulsion within the fluid container to at least partially separate the hydrocarbon fluid emulsion into at least a water phase and a hydrocarbon phase.

24. The system of claim 23, wherein the hydrocarbon phase comprises oil.

25. The system of claim 23, wherein the interaction of the magnetic field and the electromagnetic field generates vibration energy directed through the fluid container and to the hydrocarbon fluid emulsion within the fluid container to at least partially separate the hydrocarbon fluid emulsion into at least the water phase and the hydrocarbon phase.

26. The system of claim 23, wherein the fluid container comprises a pipeline, and the hydrocarbon fluid emulsion comprises a dynamic flow of a mixed-phase hydrocarbon fluid that comprises the water phase and the hydrocarbon phase.

27. The system of claim 23, wherein a thickness of the fluid container is sufficient for the acoustic wave energy to achieve a frequency of 20 KHz.

28. The system of claim 23, wherein the conductive metal is a first conductive metal, and the plurality of EMATs are coupled with the fluid container through a sleeve comprised of a second conductive metal.

29. The system of claim 28, wherein the first and second conductive metals are different.
